(19) United States
(12) Patent Application Publication
(10) Pub. No.: US 2019/0144122 A1
(43) Pub. Date: May 16, 2019

(54) METHODS AND SYSTEMS FOR SELF-LUBRICATING ICEPHOBIC ELASTOMER COATINGS

(71) Applicants: Eric Loth, Charlottesville, VA (US); Athanasios Milionis, Charlottesville, VA (US); Yong Han Yeong, Charlottesville, VA (US); Jagdish S. Sokhey, Indianapolis, IN (US)

(72) Inventors: Eric Loth, Charlottesville, VA (US); Athanasios Milionis, Charlottesville, VA (US); Yong Han Yeong, Charlottesville, VA (US); Jagdish S. Sokhey, Indianapolis, IN (US)

(21) Appl. No.: 16/099,963

(22) PCT Filed: May 9, 2017
(86) PCT No.: PCT/US17/31796

§ 371 Date: Nov. 8, 2018

Related U.S. Application Data
(60) Provisional application No. 62/333,366, filed on May 9, 2016.

(51) Int. Cl. B64D 15/00; B64F 5/40; B05B 7/00; B05B 9/01; C09D 5/00; C09D 183/04; C09D 7/40; C09D 7/61; C09D 7/20

(52) U.S. Cl. CPC B64D 15/00; B64F 5/40; B05B 7/0081; B05B 9/01; C09D 7/20; C09D 183/04; C09D 7/67; C09D 7/61; C09D 5/00

(57) ABSTRACT

Methods and systems for providing self-lubricating icephobic elastomer coatings (SLICs) can include forming the coatings from a three-component composition of a silicon elastomer, silicone oil, and a solvent, such as xylene. The coatings can provide ultra-low ice adhesion and high durability levels for a variety of applications operating in harsh icing environments, such as in aviation. In an example, the coatings or SLICs can be used in combination with a localized heating component to provide a Coating Heating Ice Protection (CHIP) system to minimize ice adhesion on the surface of an aircraft component, such as an airfoil or fan blades. Methods and systems for evaluating the ice release performance of the coatings can include high speed impaction of supercooled droplets on rotating fan blades to evaluate the coatings under conditions more representative of in-flight ice conditions, as compared to traditional testing methods.

### CROSS REFERENCE TO RELATED APPLICATIONS

This application is a national stage entry under 35 U.S.C. § 371 of PCT Application No. PCT/US2017/031796, filed May 9, 2017, which claims the benefit of U.S. Provisional Patent Application Ser. No. 62/333,366, titled “ANTI-ICING NANO-COMPOSITE POLYMER COATINGS AND RELATED METHODS THEREOF,” which was filed on May 9, 2016. The entire contents of PCT Application No. PCT/US2017/031796 and U.S. Provisional Patent Application Ser. No. 62/333,366 are incorporated herein by reference.

### BACKGROUND

Ice accumulation on solid surfaces of aircrafts, wind turbines, heat exchange elements, roads and power cables can result in car accidents, malfunctioning of transmission lines, decrease of heat transfer efficiency, impart structural damage and instabilities in wind turbines, and even cause catastrophic aircraft accidents. There are several tragic examples of flight crashes due to ice build-up and resulting in fatalities. Thus there has been a focus on developing surfaces that facilitate the removal of ice or retard its formation.

The safety and performance of modern aircraft are significantly reduced even by light, scarcely visible ice on airfoils, compression inlets of air-breathing engines, and air flow measurement instruments. The exterior of the aircraft can collide with super-cooled water droplets (0 to 500 μm in size) at altitudes between about 2740-6100 m (about 9000-20000 feet) when flying through cirrus clouds or encountering freezing rain, and the impacting water freezes rapidly to accrete on the aircraft surface. Ice accretion on aircraft surfaces, such as leading edges of wings, propellers, rotor blades, and engine intakes, can result in a dangerous loss of lift force, which can cause the aforementioned tragic crash accidents.

Current aircraft ice retardation strategies can include anti-icing equipment, which can be turned on before entering icing conditions and is designed to prevent ice from forming, usually by keeping the temperature above the freezing point. Such equipment can include electric thermal heating systems and anti-ice systems that use hot compressed air (called bleed air) that is tapped off the compressor section of the engines to prevent ice from forming on critical engine components, such as the air inlet lip and the turbine engine inlet guide vanes. Fluid freeze point depressant systems which are organic liquids whose crystallization temperatures are much lower than that of water are also widely applied on the surface of aircrafts to prevent icing and frosting.

Deicing equipment is designed to remove ice after it begins to accumulate on the airframe such as in the case of pneumatic boot systems that expand and contract on ice-prone areas of the aircraft or helicopter. Electric thermal heating systems can decrease flight operating efficiency while fluid freeze point depressants are only effective for short durations and may also cause various environmental problems.

Passive approaches can be more attractive since they do not require energy input to function. Passive approaches can be further divided in different subcategories depending on the type of surface characteristics. Examples of passive approaches are low surface energy polymers/lubricant materials that constitute hydrophobic and superhydrophobic surfaces. However, it can be extremely challenging to make a superhydrophobic material mechanically durable in order to be a good candidate for aerospace applications or in an application where mechanical shear is often present. Lubricated micro-/nano-textured surfaces can potentially provide better icephobicity compared to superhydrophobic surfaces because they maintain a liquid layer on the interface with the accreted ice which is extremely slippery. On the other hand, they can be more sensitive in terms of mechanical and lubricant stability and thus may not be suitable in many applications.

### OVERVIEW

Methods and systems for providing self-lubricating icephobic elastomer coatings (SLICs) can include forming the coatings from a three-component composition of a silicon elastomer, silicone oil, and a solvent, such as, but not limited to, xylene. The coatings can provide ultra-low ice adhesion and superior strength, compared to existing commercial products, for a variety of applications operating in harsh icing environments, such as in aviation. An optimization of silicone oil infusion levels and an optimization of xylene relative to the silicone elastomer can facilitate such performance. Moreover, the silicone elastomer can include fillers, such as crystalline silicon dioxide, in addition to the infused-oil to enhance the performance of elastomer matrix. The coatings can combine multiple properties that can synergistically enhance the ice release effect, i.e., hydrophobicity, low surface roughness, coating elasticity, and lubrication-enabled interfacial slippage.

Examples according to the present application can include an aircraft anti-icing system having an oil-infused silicone elastomer composition for use as an ice-phobic coating, the composition comprising a silicone elastomer ranging between about 43 and about 65 weight percent of the composition, a silicone oil ranging between about 2.5 and about 14.5 weight percent of the composition, and xylene ranging between about 28 and about 50 weight percent of the composition. The silicone oil can be infused into the silicone elastomer. The composition can be configured to be coated onto an aircraft component, such as, for example, one or more airfoils or engine blades.

In an example, the weight percent of the silicone elastomer in the composition can be about equal to the weight percent of the xylene in the composition. In an example, the composition can be moisture-cured. In an example, the silicone elastomer can include crystalline silicon dioxide, such as quartz nanocrystals, in combination with the amorphous silicon dioxide.

In an example, the oil-infused silicone elastomer composition can be used with a heating component for placement on a leading edge of the aircraft component or inside the aircraft component in proximity to a leading edge. The oil-infused silicone elastomer composition can be applied as a coating on a surface of the aircraft component surrounding the leading edge, and the heating component can be used in combination with the oil-infused silicone elastomer composition to minimize ice adhesion on the surface of the aircraft component.

Examples according to the present application can include an oil-infused silicone elastomer composition for use as an ice-phobic coating. The composition can comprise a silicone elastomer comprising amorphous silicon dioxide and crystalline silicon dioxide, a silicone oil ranging between about 5 and 20 weight percent relative to a weight percent of the silicone elastomer, a solvent. The silicone oil can be infused into the silicone elastomer and the composition can be configured to be coated onto an aircraft component. In an example, the solvent can be xylene. In an example, a weight percent of the solvent in the composition can be about equal to a weight percent of the silicone elastomer in the composition. In an example, the crystalline silicon dioxide in the silicone elastomer can comprise quartz nanocrystals.

Examples according to the present application can include a method of making an oil-infused elastomer composition for use as an ice-phobic coating. The method can include mixing a silicone elastomer with xylene to form an intermediate composition, a weight percent of the silicone elastomer in the intermediate composition can be approximately equal to a weight percent of the xylene in the intermediate composition. The method can further include adding a silicone oil to the intermediate composition to form an oil-infused elastomer composition. A weight percent of the silicone oil in the oil-infused elastomer composition can range between about 5 and about 20 weight percent relative to the weight percent of the silicone elastomer in the oil-infused elastomer composition. In an example, the weight percent of the silicone oil in the oil-infused elastomer composition can range between about 10 and about 15 weight percent relative to the weight percent of the silicone elastomer in the oil-infused elastomer composition.

Examples according to the present application can include a method of forming an oil-infused elastomer coating on an aircraft component. The method can include making or providing a composition comprising xylene ranging between about 43 and about 50 weight percent of the composition, a silicone elastomer ranging between about 43 and about 50 weight percent of the composition, and a silicone oil ranging between about 2.5 and about 14 weight percent of the composition, the silicone oil infused into the silicone elastomer. The method can include applying the composition to a least a portion of the surface of the aircraft component and curing the composition at ambient conditions to form the oil-infused elastomer coating on the surface of the aircraft component. Applying the composition to at least a portion of the surface can include at least one of drop casting, flow coating, spin coating, dip coating, and spraying. Applying the composition to at least a portion of the surface can include applying two or more layers of the composition onto the aircraft component and curing the composition after each layer is applied.

Examples according to the present application can include a method of protecting on one or more components of an aircraft from ice formation during operation of the aircraft. The method can comprise installing a heating element inside or on an aircraft component, proximate to a leading edge of the aircraft component. The method can further comprise making or providing a composition comprising a silicone elastomer infused with silicone oil and applying the composition on a surface of the aircraft component surrounding the leading edge to create a self-lubricating ice-phobic coating. The heating element and the coating can work in combination to protect the aircraft component from ice formation. The heating element can be a resistive heating element, such as a tubular heater or an electrically conductive foil.

Examples according to the present application can include a testing system for evaluating ice adhesion. The testing system can include an icing chamber to cool the air in the chamber to temperatures less than or equal to 20 degrees below Celsius. The testing system can include a motor-driven propeller configured to receive a plurality of fan blades and rotate the plurality of fan blades, a portion of the plurality of fan blades having a surface coating for evaluation. The testing system can include a spray nozzle connected to a water supply and an air supply, the spray nozzle configured to spray water droplets onto tips of each fan blade during rotation of the fan blades by the propeller. The testing system can more closely mimic in-flight icing conditions, compared to traditional static tests, in order to evaluate performance of a surface coating. The propeller can be configured to rotate the fan blades at about 1000 rpm.

Examples according to the present application can include a method of evaluating ice adhesion on fan blades coated with a hydrophobic or icephobic coating. The method can include mounting two or more fan blades on a motor-driven propeller configured to rotate the fan blades at speeds up to about 1000 rpm, the propeller housed within a chamber, and cooling the chamber to a temperature at or below 0 degrees Celsius. The method can further comprise spraying droplets through an atomizing nozzle connected to an air supply and a water supply and directing the droplets onto the rotating fan blades to accrete ice on the blades. The method can then comprises turning off cooling to the chamber, turning off the atomizing nozzle, and determining the temperature in the chamber at which ice on the rotating blades sheared from the rotating blades. In an example the chamber is cooled to −20 degrees Celsius. In an example, directing the droplets onto the rotating fan blades includes impacting the blades with supercooled drops at about 25 m/s. In an example, the method can comprise conducting a pre-test spray by deflecting the spray from the atomizing nozzle and away from the fan blades.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

FIG. 1 illustrates generally an example self-lubricating icephobic elastomer coating (SLIC) having an infused silicone oil in an elastomeric matrix.

FIG. 2 illustrates generally an example testing system for evaluating ice adhesion.

FIG. 3 illustrates generally a top view of a fan assembly of the testing system of FIG. 2.

FIG. 4 illustrates generally a top view of a protective mesh for covering the fan assembly of FIG. 3.

FIG. 5 is a plot of the ice shear temperatures for multiple tests of various coatings under evaluation.

FIG. 6 is a plot of the averaged ice shear temperature of each of the various coatings.

FIG. 7 is a plot of slide-off angle measurements of SLIC surfaces as a function of time, when subjected to abrasive damage with a medium-coarse abradant.

FIG. 8 is a plot of slide-off angle measurements of SLIC surfaces as a function of time, when subjected to abrasive damage with a crocking cloth.

FIG. 9 is a plot of the ice shear temperatures of SLICs following a spinning durability test, as compared to averaged ice shear temperatures of the SLICs without the spinning durability test.

FIG. 10 is a plot of the ice shear temperatures of SLICs following abrasion tests and heating, as compared to the average ice shear temperatures for the SLICs without the abrasion tests.

FIG. 11 is a plot of the ice shear temperatures of SLICs following thermal cycling, as compared to the average ice shear temperatures for the SLICs without thermal cycling.

FIG. 12 is a plot of the ice shear temperatures of a SLIC at 10% oil and 0.5:1 ratio of xylene to silicone elastomer, for multiple spray tests, as compared to SLICs at a 1:1 ratio of xylene to silicone elastomer.

FIG. 13 illustrates generally an example ice protection system having localized heating in combination with the SLICs described herein.

FIG. 14 illustrates generally another example ice protection system having localized heating in combination with the SLICs described herein.

FIG. 15 illustrates generally an example testing system for testing the ice protection systems of FIGS. 13 and 14.

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

### DETAILED DESCRIPTION

The present application is directed to durable, self-lubricating icephobic elastomer coatings (SLICs) formed from a three-component composition of a silicon elastomer, silicone oil, and a solvent, such as, but not limited to, xylene. Through an optimization of silicone oil infusion levels within a robust, weather-resistant silicone elastomer matrix and an optimization of xylene levels, the coating can provide ultra-low ice adhesion and high durability levels for a variety of applications operating in harsh icing environments, such as in aviation. In an example, the coatings can be suitable for use on the surface of various aircraft components or parts. The surface of the aircraft components or parts can commonly be formed of aluminum or aluminum alloys, for example. The coatings described herein can combine multiple properties that can synergistically enhance the ice release effect, i.e., hydrophobicity, low surface roughness, coating elasticity, and lubrication-enabled interfacial slippage. As shown below, the coatings exhibited superior strength compared to existing commercial products.

As described herein, in an example, the coatings or SLICs can be used in combination with a localized heating component to provide a Coating Heating Ice Protection (CHIP) system to minimize ice adhesion on the surface of an aircraft component, such as, for example, an airfoil.

For purposes of the present application, “SLIC” refers herein to a coating having the three-part composition of a silicone elastomer, a silicone oil infused into the silicone elastomer, and a solvent. In an example, the solvent can be xylene. It is recognized that once the coating is applied to the surface, the solvent evaporates. The coatings described herein having the three part composition can also be referred to as Hydrophobic Oil-Infused Elastomer (HOIE) coatings.

The present application also provides a testing method and system to evaluate the ice release performance of the coating, as compared to existing commercial products. The testing method and system disclosed herein can involve high speed supercooled droplet impact on coated fan blades rotating at speeds of about 1000 rpm. Such testing method and system can evaluate the coating under dynamic conditions intended to mimic in-flight ice conditions. This is in contrast to the traditional static testing conditions which are not representative of in-flight conditions. Such supercooled drop impact icing experiments on rotating fan blades at RPMs of the same order of magnitude as commercial aircraft engines showed that the SLICs can repeatedly reduce the ice on the surface, relative to other commercial hydrophobic and superhydrophobic coatings. In addition, the SLICs displayed long-term self-replenishing lubrication. After repeated mechanical abrasion of the surface, lubricants stored within the bulk of the coating can continuously migrate to the surface to replace the lost lubricants, thus promoting low ice adhesion. Durability tests also showed that the SLICs can withstand long-term micron-sized droplet impact without coating degradation.

The SLICs can be formed through the combination of a silicone elastomer and a silicone oil. The silicone oil can be used given similar chemistry to silicone elastomer. A solvent can be used for diluting the silicone elastomer. The silicone oil can be added to the elastomer/solvent solution and infused into the silicone elastomer such that the coating can be self-replenishing. The SLICs are referred to herein as a three-part composition since the original composition is formed by combination of the silicone elastomer, the silicone oil and the solvent (xylene). However, it is recognized that once the three-part composition is applied to the targeted surface, the xylene generally evaporates and the remaining coating is generally a two-part composition of silicone elastomer infused with silicone oil.

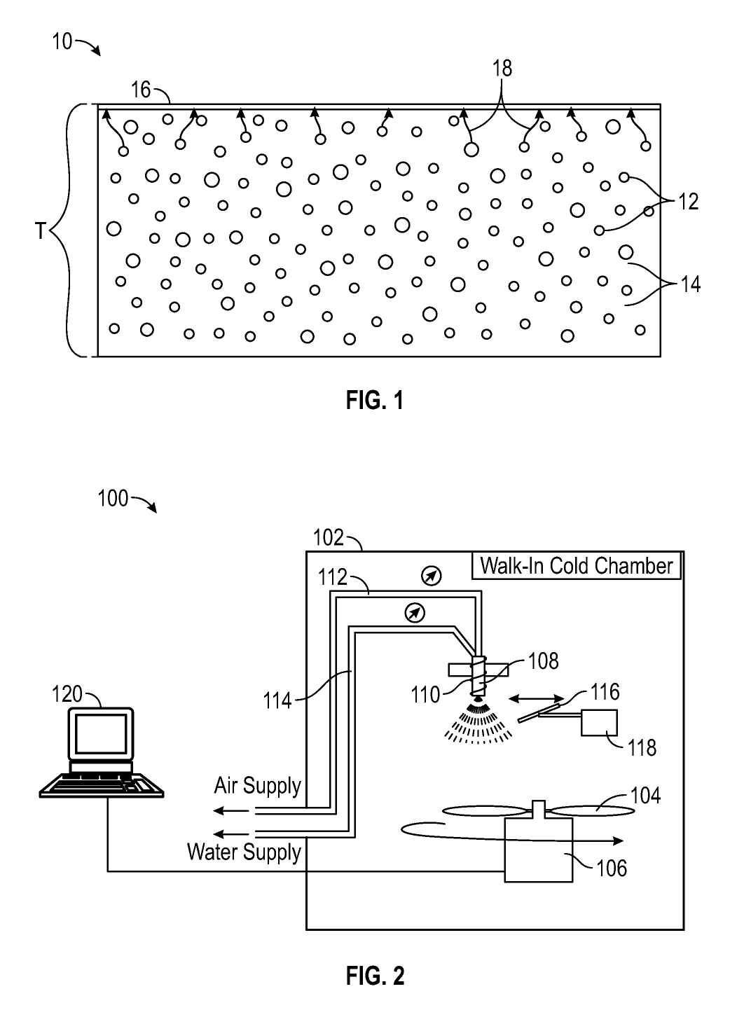

FIG. 1 is a schematic of a coating 10 having an infused silicone oil 12 stored inside an elastomeric matrix 14 in the form of discrete shell-less micro-droplets 12. The coating 10 can also be referred to as an SLIC and can have a coating thickness T. The coating 10 can include a thin lubricated layer 16 (formed of the lubricant/silicone oil 12) on an exposed surface of the coating 10. The lubricated layer 16 can be replenished by gradual migration of the infused lubricant 12 (as indicated by arrows 18). Due to the tendency of the silicone oil/lubricant 12 to migrate towards the surface, the elastomeric matrix 14 can act as a mechanically stable reservoir that can continuously supply the surface with fresh lubricant and compensate for losses due to mechanical shear.

The coating 10 can have a low surface energy owing to the intrinsic hydrophobic nature of siloxane elastomers. The elasticity of the elastomer 14 can create stresses at the ice-coating interface and enhance the ice release properties. The coating 10 can have minimal surface roughness which can ensure that accreted ice does not “lock” and adhere tightly, as can be the case for a superhydrophobic surface. The self-replenishing lubricating top layer 16 can minimize ice adhesion due to interfacial slippage.

In an example, the thickness T for the SLICs described herein can be between about 100 and about 200 μm. In other examples, the thickness T may be less than about 100 μm or more than about 200 μm.

A silicone elastomer suitable for use in the SLICs disclosed herein can include a silicone elastomer with sufficient strength properties to withstand harsh environmental conditions while maintaining elasticity. In an example, the silicone elastomer can be a one part silicone elastomer. In an example, the silicone elastomer can include suspended nanoparticles. The suspended nanoparticles can be used as filler within the elastomeric matrix of the silicone elastomer. When the silicone oil is infused into the silicone elastomer, a combination of the infused silicone oil and the suspended nanoparticles can increase a strength and performance of the elastomeric matrix. In an example, the silicone elastomer can include amorphous silicon dioxide in combination with a crystalline form of silicon dioxide, such as quartz nanocrystals. In an example, the silicone elastomer can include oximino silane as a cross-linking agent and can be moisture activated.

In an example, the silicone elastomer includes quartz nanocrystals which can be suspended in the amorphous silicon dioxide. The quartz nanocrystals may provide strength to the elastomeric matrix of the silicone elastomer and may contribute, in part, to the superior performance of the three-part compositions disclosed herein. It is recognized that other types of crystalline silicon dioxide (or combinations thereof) may be used in place of or in addition to quartz, such as, for example, cristobalite or tridymite.

In an example, the SLIC can be formed from a composition comprising a silicone elastomer ranging between about 43 and about 65 weight percent of the composition, a silicone oil ranging between about 2.5 and about 14.5 weight percent of the component, and xylene (or other suitable solvent mixtures like Naphtha, etc.) ranging between about 28 and about 50 weight percent of the composition.

In an example, the SLIC can be formed from a composition comprising a silicone elastomer ranging between about 43 and about 50 weight percent of the composition, a silicone oil ranging between about 2.5 and about 14 weight percent of the component, and xylene (or other suitable solvent mixtures like Naphtha, etc.) ranging between about 43 and about 50 weight percent of the composition. In an example, the silicone elastomer can range between about 44 and about 47.5 weight percent of the composition, the silicone oil can range between about 5 and about 11.5 weight percent of the composition, and the xylene can range between about 44 and about 47.5 weight percent of the composition. In an example, the weight percent of the xylene is about 44.4, the weight percent of the silicone elastomer is about 44.5 percent and the weight percent of the silicone oil is about 11.1 weight percent. In an example, the weight percent of the xylene is about 47.3 weight percent, the weight percent of the silicone elastomer is about 47.4 weight percent, and the weight percent of the silicone oil is about 5.3 weight percent.

In an example, the SLIC can be formed from a composition comprising a silicone elastomer, a silicone oil, and xylene (or other suitable solvents), and a weight percent of the silicone oil can range between about 5 and about 20, relative to a weight percent of the silicone elastomer in the composition. In an example, the silicone oil can range between about 10 and about 20 weight percent relative to a weight percent of the silicone elastomer in the composition. In an example, the silicone oil can be about 5 weight percent relative to the weight percent of the silicone elastomer. In an example, the silicone oil can be about 10 weight percent relative to the weight percent of the silicone elastomer. In an example, the silicone oil can be about 20 weight percent relative to the weight percent of the silicone elastomer.

In an example, a weight percent of the xylene in the composition can be about equal to a weight percent of the silicone elastomer in the composition. In other words, the composition can have a 1:1 ratio of xylene to silicone elastomer.

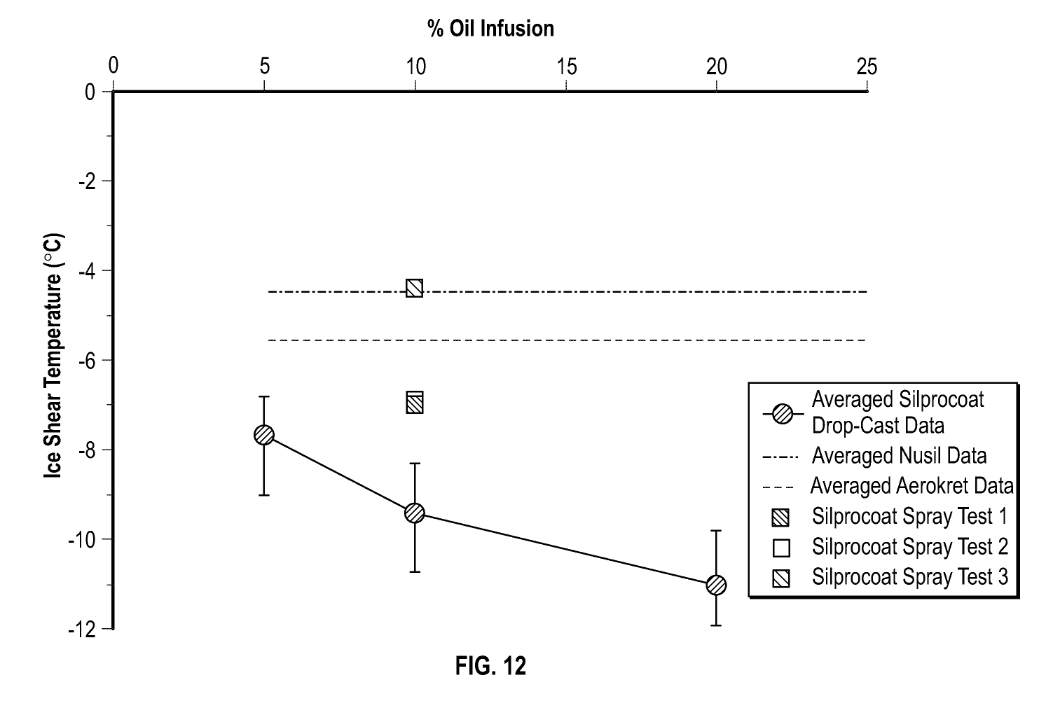

In another example, a weight percent of the xylene in the composition can be about half of the weight percent of the silicone elastomer in the composition. In other words, the composition can have a 0.5:1 ratio of xylene to silicone elastomer. At this reduced amount of xylene, there may still be sufficient durability and ice adhesion, and the coating performance can be comparable to exiting commercial products. However, such performance at this reduced ratio of xylene to silicone elastomer can be inferior to a composition having a 1:1 ratio of xylene to silicone elastomer. (See FIG. 12 and corresponding description below.)

In general, if too much xylene is used, the composition can have insufficient viscosity and oil agglomerations can be observed. In general, if too little xylene is used, a smooth coating on the surface cannot be obtained since the silicon elastomer tends to be viscous and have at least a minimal amount of roughness. Thus the compositions provided herein include xylene at a level that provides uniformity within the coating and good rheological properties.

Although xylene is focused on herein as the solvent for use in combination with the silicone elastomer and silicone oil, it is recognized that another type of solvent may be used. Other suitable solvents may include naphtha, toluene or other hydrocarbon mixtures. If another solvent is substituted for xylene generally at the same weight percent provided herein, it may be preferable for such other solvent to have an evaporation rate similar to xylene since the evaporation rate can impact the application of the coating to the surface.

In an example, the silicone elastomer used in the SLICs described herein can be a moisture-cured elastomer. In contrast to other types of silicone elastomers which can require one or more heat treatments for curing, the silicone elastomer used in the SLICs can be moisture-cured such that after the SLIC is coated on the surface of a part or component, the part or component can be left at ambient conditions (assuming moisture in surrounding air) for a short period (less than 8 hours). In an example, the curing time can be about 3-5 hours. It is recognized that the humidity of the air can influence curing time. Use of a moisture-cured elastomer can simplify the process of applying the SLICs to the surface.

The three-part composition of silicone elastomer, silicone oil and solvent can be applied to a surface of a part or component using various methods and techniques in order to form the SLIC. Such methods and techniques can include but are not limited to drop casting, flow coating, spin coating, dip coating/immersion and spraying. It is recognized that a particular method of application selected can depend on a ratio of the three parts in the composition. For example, at a 1:1 ratio of xylene to silicone elastomer, a drop casting method may be more suitable compared to other methods, whereas at a 0.5:1 ratio of xylene to silicone elastomer, spraying may be more suitable compared to other methods. As described above the composition of the SLICs can be moisture-cured and may not require any heating for the composition to cure and form a coating adhered to the surface. In an example, multiple layers of the composition can be applied to the surface. A curing step can be performed after each layer is added.

The performance of the SLIC at varying levels of oil-infusion (5%, 10% and 20%) was compared with hydrophobic, superhydrophobic, and other commercial silicone-based icephobic coatings. The SLICs were found to outperform the other materials in terms of reducing the ice adhesion strength while at the same time maintaining high level of mechanical robustness under super-cooled drop impact, long-term centrifugal force loading and repeated cycles of linear mechanical abrasion.

For the testing described below, each of the SLIC compositions consisted of three components, i.e. a silicone elastomer (Silprocoat™, Midsun Group, USA), silicone oil (Baysilone®, Sigma Aldrich) and a solvent (Xylene, Fisher Scientific). The silicone elastomer was diluted in Xylene and manually stirred for a few minutes to obtain a uniform and intermediate solution. Subsequently, the silicone oil was slowly added to the intermediate solution. The final solution was stirred again for a few minutes. The silicone oil was added in three different concentrations—5%, 10% and 20%, relative to the amount of silicone elastomer present in the solution. The specific weight percent of each of the three components for each of the three SLIC compositions is shown below in Table 1.

TABLE 1
Composition of SLICs tested

| | Silprocoat wt % | Baysilone wt % | Xylene wt % |
|---|---|---|---|
| SLIC 5% | 48.7 | 2.6 | 48.7 |
| SLIC 10% | 47.4 | 5.3 | 47.3 |
| SLIC 20% | 44.4 | 11.1 | 44.5 |

The specific formulations shown in Table 1 were used in the majority of the testing described herein. As established below, the formulations having SLICs at 5%, 10% and 20% silicone oil (relative to a weight percent of the silicone elastomer) showed superior performance, particularly SLICs having 10% and 20% silicone oil. Other formulations having silicone oil between 10 and 20 weight percent are expected to achieve similar performance, particularly at a 1:1 ratio of silicone elastomer to solvent. It is recognized that other formulations of the three-component composition (silicone elastomer, silicone oil and solvent) can be used in addition to those specifically provided here in Table 1 (and also Table 3). Such other formulations can include other ratios of silicone elastomer to solvent or other percentages of silicone oil (relative to a weight percent of the silicone elastomer).

Prior to the coating application, the substrate (fan blade) was roughened with P320 sandpaper and cleaned with isopropyl alcohol. The fan blades were then wrapped with adhesive tape, leaving only the leading edge region for application of the coating. The final solution was drop-casted on the leading edge areas of the fan blades and left to cure for about 4 hours in ambient conditions. (Note that the blades could alternatively be flow coated to speed up the coating application.) After curing, a second coating layer was applied in an identical procedure. The final coating was left to cure overnight, after which the adhesive tape was removed.

In addition to the three SLICs, various types of commercial coatings were also applied on the fan blades for ice shear performance evaluation and other tests. Such commercial coatings included superhydrophobic coatings (Hydrobead), two hydrophobic hard coatings (DuPont Teflon 852G-201 and Nanosonic HybridShield) and two hydrophobic elastomer coatings (Nusil R-2180 and Aerokret, Analytical Services & Materials, Inc.). All of these coatings were applied on the fan blades via spray-casting techniques.

Table 2 below lists the different commercial coatings tested for comparison with SLIC at 5%, 10% and 20% silicone oil.

TABLE 2
Tested coatings, application method and wetting properties

| | | | | | Water |
|---|---|---|---|---|---|
| | | | | Water | Roll-off |
| | | Coating | Application | Contact | Sliding |
| No. | Coating | Type | Method | Angle(*) | Angle(*) |
| 1 | Hydrobead | Super- | Spray | 166 | 2 |
| | | hydrophobic | | | |
| 2 | DuPont | Hydrophobic | Spray | 117 | 30 |
| | Teflon | | | | |
| 3 | Nanosonic | Hydrophobic | Spray | 103 | 44 |
| | HybridShield | | | | |
| 4 | NuSil | Hydrophobic | Spray | 111 | 62 |
| | R-2180 | Elastomer | | | |
| 5 | Aerokret | Hydrophobic | Spray | 118 | 64 |
| | | Elastomer | | | |
| 6 | SLIC 5% | Self- | Drop-casting | 106 | 18 |
| | | Lubricating | | | |
| | | Elastomer | | | |
| 7 | SLIC 10% | Self- | Drop-casting | 106 | 14 |
| | | Lubricating | | | |
| | | Elastomer | | | |
| 8 | SLIC 20% | Self- | Drop-casting | 104 | 8 |
| | | Lubricating | | | |
| | | Elastomer | | | |

Water contact angles (accuracy of ±5°) were measured through the sessile drop method with an automated goniometer, (290-F4, Ramé-Hart) using 10 μl deionized water drops at 3 different locations on the substrate and averaged. Roll-off/sliding angles were recorded by gradually tilting the surface until 20 μl water drops started to slide. The surface morphology of the SLIC was analyzed using a Scanning Electron Microscope (SEM) (Quanta 650, FEI USA) at the Nanoscale Materials Characterization Facility at the University of Virginia. Prior to imaging, the samples were sputter-coated with a thin Au/Pd layer (20 nm) by using a Precision Etching Coating System (PECS) (Model 682, Gatan, USA) to eliminate charging effects.

Given the difference in composition and application method, a coating thickness of the eight compositions of Table 2 was not necessarily the same from coating to coating. The thickness of the three SLICs was estimated to be between about 100 and about 200 μm. The thickness of the HybridShield was estimated to be about 30 μm. For NuSil R-2180 the solution was diluted (20% solvent) and the coating thickness was estimated to be between about 80 and about 100 μm. The Aerokret composition was mixed with primer and the coating thickness was between about 150 and about 200 μm.

It can be observed that the SLIC exhibited hydrophobic static and dynamic characteristics, with static contact angles at approximately 105° and slide-off angles of less than 20°. The slide-off angle of the SLIC was found to be lower than the commercial Teflon coating (slide-off angle of 30°). Such improvement may be due to the inherent hydrophobic nature of the commercial silicone elastomer used in the SLICs. The static contact angle and slide-off angles of the elastomer without oil infusion were measured separately to be 106° and 25°, respectively. Such anti-wetting performance is considered excellent for a smooth coating. Hydrophobicity can only be further increased by introducing surface roughness (e.g. superhydrophobic coating Hydrobead) or lubrication which often decreases its mechanical durability.

As shown in Table 2, the infusion of silicone oil into the elastomer lowered the sliding angle of the SLIC as it provided additional slippage between the water drop and the coating. An increased amount of oil infusion may result in further decrease of the sliding angle due to the increased presence of oil for additional slippage. For example, the sliding angle of a SLIC infused with 5% silicone oil was 18°, as compared to 8° for a SLIC infused with 20% silicone oil. It should also be noted that the infusion of silicone oil into the elastomer did not affect the static contact angles.

Optical images of the coatings in Table 2 showed a visibly decreasing surface roughness as the weight percentage of oil infusion in the SLICs increased from 5% to 20%. This can be attributed to the increased layer of lubrication on the surface of the coating, which can correspond with the decreasing slide-off angles. SEM images revealed the presence of minor surface indentations of approximately 5 μm, which can be attributed to a minimal incompatibility between the silicone lubricant and the elastomeric matrix. Such indentations can also be observed for SLICs with higher lubricant concentrations. Despite the presence of these micron-sized indentations, neither the coating durability, nor the anti-wetting performance was affected, as shown in Table 2. Sliding angle values decreased for increased oil infusion. There were no significant differences observed in the coating's uniformity at the macroscopic level. The indentations did not affect the ice shear performance of the coatings. On the contrary, it may be possible that such indentations facilitated the secretion of the infused silicone oil and therefore enhanced the self-replenishing surface lubrication, which in turn can reduce the ice adhesion.

The effectiveness of the SLICs and other coatings of Table 2 in reducing ice adhesion was tested by performing an icing experiment under realistic atmospheric/aerospace ice accretion conditions. The conditions and equipment described herein for evaluating ice adhesion more closely mimic in-flight conditions, as compared to existing testing which typically applies the coating to the surface of a part and then stores the part in a freezer, and ice adhesion is determined shortly thereafter (usually a few hours later). Such static freezing is significantly different that subjecting the coated part to dynamic conditions, as described below.

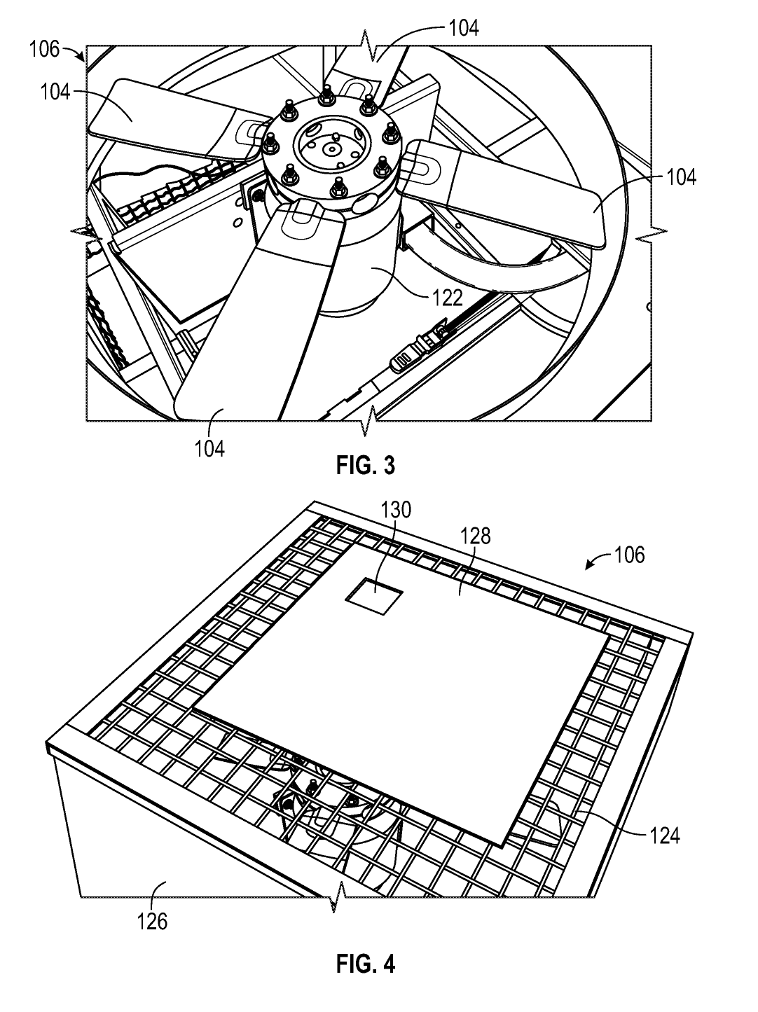

FIG. 2 is a schematic of an example testing system 100 which can include a walk-in cold chamber or icing chamber 102 having a set of four aluminum alloy fan blades 104. The fan blades 104 can be part of a fan assembly 106 and can be configured for receiving a coating on at least a portion of the blade 104. (The fan blade assembly 106 is described further below in reference to FIG. 3.) The fan assembly 106 can be enclosed within a fan guard box and protected with a cover. (See FIG. 4.)

The chamber 102 can include a spray nozzle 108, such as an air atomizing spray nozzle, for producing air droplets. The spray nozzle 108 can include heat tape 110 wrapped around an exterior of the spray nozzle 108. The system 100 can include an air hose 112 for delivering an air supply to the nozzle 108 and a water hose 114 for delivering a water supply to the nozzle 108. Each of the air hose 112 and the water hose 114 can be thermally wrapped to prevent freezing. The system 100 can include a shield 116 which can be extended using a motor 118 to deflect the droplets away from the fan assembly 106 during a pre-test spray, as described further below. The system 100 can include a computer 120 (and a variable frequency drive) located external to the chamber 102 and configured for operational control of the fan assembly 106.

FIG. 3 is a top view of the fan assembly 106 (or propeller fan rig) with protective covering removed (see FIG. 4). The fan assembly 106 can include the four fan blades 104 mounted on a propeller 122 and driven by a motor. In an example, the motor can be a 1 hP motor.

FIG. 4 is a top view of a protective mesh 124 that can cover the fan assembly 106, which can be contained within a protective enclosure or guard box 126. A cover 128 can be secured to the protective mesh 124 and can include a spray aperture 130 for the droplets from the nozzle 108 to contact the fan blades 104. Other features such as, but not limited to, lights, a webcam and a laser tachometer are not included in FIG. 4 for simplicity.

Although the testing system 100 is described below with regard to evaluating the ice adhesion of the compositions of Table 2, it is recognized that the testing system 100 can be used on any type of surface coating used on aircraft components or other surfaces with regard to ice formation.

### Example—Ice Adhesion Test/Ice Shear Performance

The testing system 100 was used to promote ice accretion on the fan blades 104 for each of the coating compositions listed in Table 2 and then observe ice shearing. The ice shear temperatures correlate to ice adhesion. The lower the ice shear temperature, the less the ice adhered to the coating surface. In this example, the fan assembly 106 included an axial propeller fan and rig (Model TCPWX Adjustable Pitch Blades, Twin City Fan & Blower). The spray nozzle 108 included a NASA Icing Wind Tunnel Mod-1 Nozzle designed and fabricated by the NASA Icing Branch for use in the Glenn Icing Research Tunnel and capable of producing 20 μm median volume diameter (MVD) water droplets.

For the test on each of the coating compositions listed in Table 2, two of the four fan blades 104 were coated with the particular coating and the other two blades 104 remained uncoated to prevent load imbalance on the motor of the fan assembly 106. The blades 104 were 0.25 meters in span and consisted of slightly rounded leading edges with a profile resembling an approximate flat plate and also a slight twist at mid-span. The spray nozzle 108 was mounted about 78 cm above the blades 104. This distance was determined to be the optimal super-cool distance for the droplets before contact with the blades 104. The spray nozzle 108 was mounted in a position so that the water droplets would be sprayed near the tips of the rotating blades 104 for maximum droplet impact at fan tip speeds.

The icing chamber 102 was first cooled to −20° C., after which the fan blades 104 were set to rotate at 1000 rpm (same order of magnitude as commercial aircraft engine blades) with an initiation of a pre-test spray at 35 kPa (5 psi) air pressure and 450 kPa (20 psi) water pressure. This pre-test spray lasted for 3 minutes to allow for the water to reach steady state temperature conditions. During the pre-test spray, the automated shield 116 was extended using the motor 118 to deflect the spray away from the fan assembly 106 so that the pre-spray droplets would not prematurely impact the rotating blades 104. The air pressure was increased to the operating pressure of 138 kPa (20 psi) for an additional minute at the end of the 3-minute pre-test spray. The shield 116 was then retracted such that the super-cooled ice accretion process on the blades 104 could commence. The impact of the micron-sized droplets on the blades 104 was about 25 m/s. Ice was allowed to accrete for two minutes on the blades 104 before the spray and freezing chamber were turned off to allow temperatures to warm. The fan assembly 106 was set to remain spinning at 1000 RPM. The ambient temperature at which ice would shear from the spinning blade 104 was recorded as the ice shear temperature of the coating. The experiment was repeated at least three times for each coating to account for experimental uncertainty and variance. Note that warming of the freezer was conducted without opening the doors of the icing chamber 102 to result in consistent chamber swarming temperature profiles for each test. Consistency was measured and confirmed by thermocouples installed in the icing chamber 102.

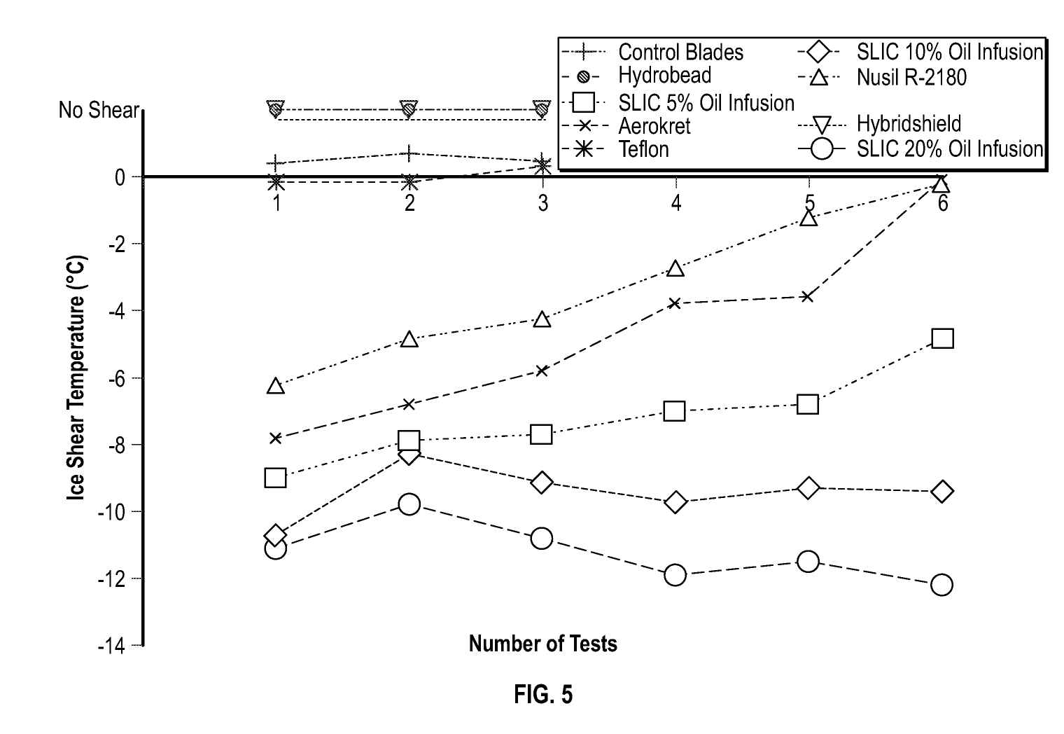

FIG. 5 shows the ice shear temperatures of the coatings for each test, which is related to the adhesion strength of ice on the coating. Ice shear strength on a surface increases with a decreasing ambient temperature. In this experiment, all of the coatings were subjected to the same centrifugal forces while the ambient temperature was gradually raised. Therefore, ice on a coating which could be sheared at lower temperatures signified a lower ice adhesion strength as compared to coatings with higher ice shear temperatures.

Three tests were performed for the control blades (fan blades without any coating), Hydrobead, HybridShield and Teflon coatings, while six tests were performed for the Aerokret, NuSil and SLIC coatings. Additional tests were not performed for the former list of coatings as each of their ice shear temperatures were generally constant over three tests and not expected to change with further repeated tests.

The results in FIG. 5 demonstrate that ice on the Hydrobead and HybridShield coatings did not shear, even though the ambient temperature had been raised beyond 1° C., indicating that the ice adhesion strength on these coatings was extremely strong. Hydrobead is a superhydrophobic coating and therefore relies on surface micro- and nano-textures, in addition to low surface energy to induce high water-repellency. The impact of the supercooled droplets on the coating caused a penetration of the liquid within the surface asperities, causing a Wenzel-type accretion and ultimately increased the ice adhesion strength due to the interlocking of ice and roughness of the surface. Even though the Hybridshield coating exhibited hydrophobicity, its wettability characteristics (contact angle of 102° and sliding angle of 43°) were less hydrophobic when compared to the Teflon coating (contact angle of 116° and sliding angle of 30°). This resulted in an ice adhesion strength that was slightly lower for Teflon (ice shear temperatures of slightly below freezing).

The ice shear temperatures for the Aerokret and NuSil R-2180 coatings were significantly lower than the Teflon and Hybridshield coatings, which signify a lower ice adhesion strength for Aerokret and NuSil R-2180. The reason for the low ice adhesion can be due, at least in part, to the elastomeric nature of the Aerokret and Nusil coatings. There are significant moduli differences between the accreted ice and the elastomer coating. If stress is applied on the ice, such as with centrifugal force in this experiment, a mismatch in strain occurs which allows for an easier release of the ice from the coating. The hydrophobicity of the Aerokret and NuSil coatings is expected to generally enhance the ice release effect. However, it was observed that the ice shear temperature of the coatings gradually increased over the 6 tests which indicated an increase of ice adhesion and degradation of ice release performance. This degradation could be due to physical changes in the coating caused by the combined effects of prolonged high speed supercooled drop impact, repeated ice accretion, presence of hydroxyl groups on the surface and shear events, as well as centrifugal force stresses on the coating created by the fan blade rotational speeds.

The lowest ice shear temperatures recorded were for the three SLICs. With the exception of the sixth test for SLIC with 5% oil infusion, all ice shear temperatures were measured to be below −7° C., which indicated a very low ice adhesion strength. Specifically, after the sixth test, the SLIC with 20% oil infusion was found to exhibit an ice shear temperature that was 12° less than the best performing non-SLIC coating (Aerokret). The reason for this effect is likely due to the combination of coating elasticity, which as previously explained promotes ice release, a hydrophobic nature of the coating, which lowers the surface energy of the coating, and the presence of lubrication on the coating surface to enhance slippage between the ice and the coating. Another factor that promotes icephobicity in the case of the SLIC coatings is the fact that increasing amounts of silicone oil inside the elastomeric matrix can lead to increased overall elasticity of the hybrid material (since silicone oil is a fluid) and this can lead to even greater strain mismatch at the ice-coating interface during the ice shear tests. As expected due to the aforementioned factors, increasing the amount of oil infusion in the coating resulted in a further decrease in the ice shear temperature. With the exception of the SLIC with 5% oil infusion, the ice shear temperatures/ice shear performance did not degrade across the six tests.

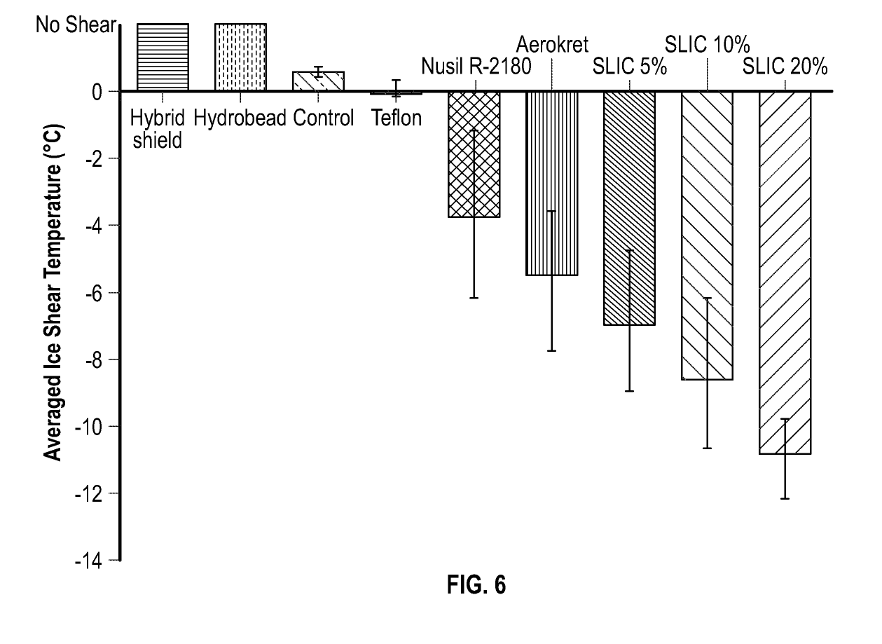

FIG. 6 is a graph with the averaged ice shear temperatures for the coatings included in FIG. 5. The error bars represent the range of shear temperatures recorded for the six tests (or three tests). FIG. 6 shows that the average of the recorded shear temperatures for the SLICs were significantly lower compared to the non-elastic coatings (Hybridshield, Hydrobead and Teflon).

### Example—Durability and Self-Replenishment

The mechanical durability of the SLICs was assessed using a linear abraser (Model 5750, Taber Industries, USA). The abraser consists of a mechanical arm with an abrasing tip that can be installed with different types of abradants. The tip and abradant are placed in contact with the test coating while the mechanical arm moves the tip in a linear fashion to abrade the test coating. Weights can be placed on the mechanical arm to increase the force of abrasion.

A crocking cloth and a medium-coarse abradant were each used with a 350 g weight to evaluate the mechanical durability of the SLICs. The crocking cloth provided a blunt abrading mechanism on the coatings, whereas the medium-coarse abradant contained abrasive particles similar to sand paper particles. The lubricant depletion and recovery were evaluated. The test involved the measurement of the sliding angle of the SLIC followed by light abrasion of the surface (2 abrasion cycles, each with 350 g of weight) using both types of abradants. The coating was then exposed to ambient temperatures for a few days before the measurement of a sliding angle was performed and the abrasion process repeated. This procedure was repeated for a duration of 21 days. The goal of the study was to assess the lubrication depletion and recovery in a realistic environment of light and gradual damage on the coating.

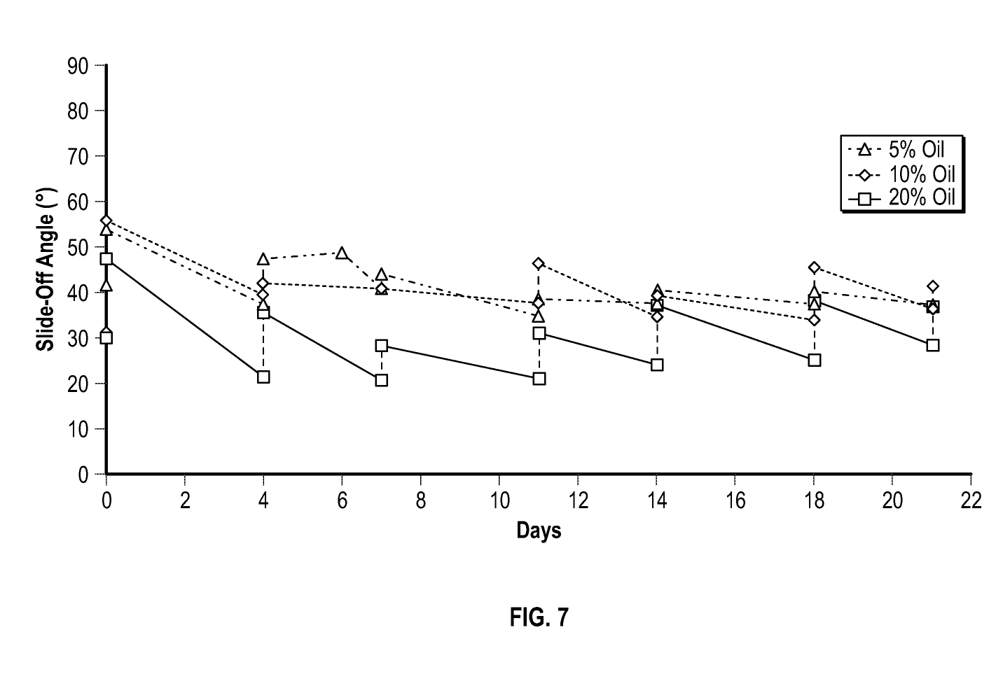

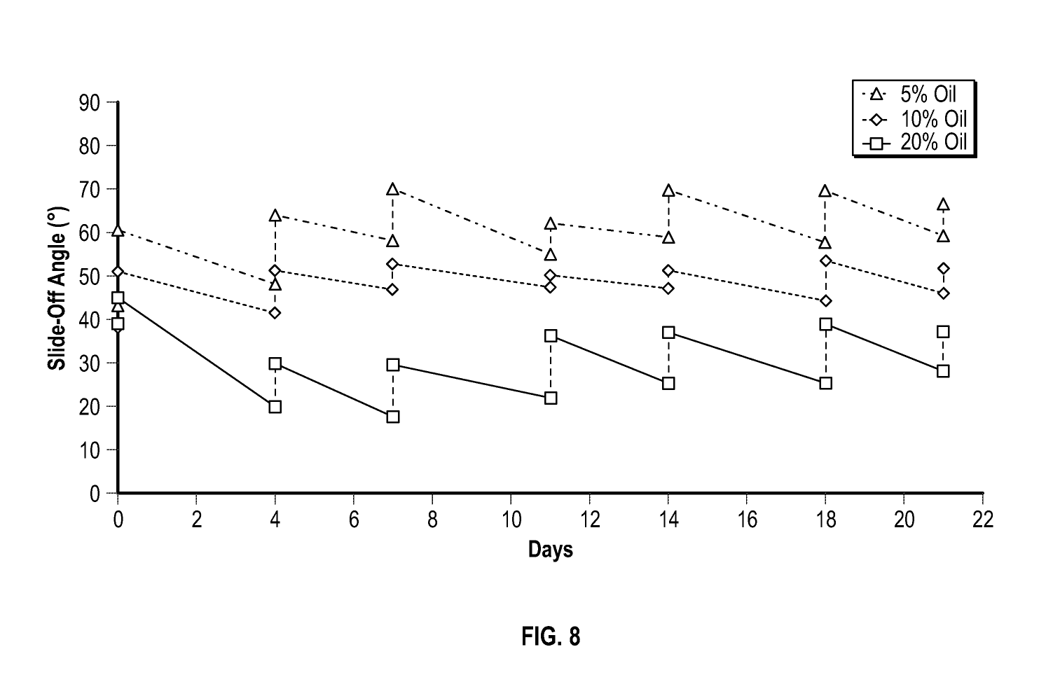

FIG. 7 is a plot of the slide-off angle measurements of the SLIC surfaces as a function of time, when subjected to light and gradual abrasive damage with a medium-coarse abradant. The dotted lines represent the change in the sliding angle immediately after abrasion and the solid lines represent the recovery. The parameter of sliding angle was chosen as it reflects the amount of silicone oil that was present on the coating surface. Thus an increase in sliding angle correlates to degradation. FIG. 7 shows that each of the three SLICs degraded (increase of sliding angle) immediately after abrasion, followed by a recovery (decrease of sliding angle) a few days later. This zig-saw pattern was consistent throughout the twenty-one days of testing. The silicone oil lubricant is able to continuously migrate within the elastomer towards the surface to compensate for the existing lubricant that was lost due to mechanical shear. At the same time, the elastomer acts as a mechanically stable reservoir to hold the lubricant until it migrates to the surface. FIG. 8 is a plot of the slide-off angle measurements of the SLIC surfaces as a function of time with a crocking cloth and under the same conditions described above. FIG. 8 shows similar results to those shown in FIG. 7.

FIGS. 7 and 8 show that the magnitude of replenishment was a function of the percentage of oil infused within the silicone elastomer. A coating with 20% silicone oil infusion replenished and recovered at a larger extent, to maintain consistently low slide off angles, as compared to the coatings with 10% and 5% oil infusion. This was due to the larger reservoir of silicone oil that was available within the coating having 20% oil; with such reservoir being able to supplement the oil on the surface that was mechanically sheared away. Due to this replenishing effect of the SLICs, ice can be repeatedly sheared away from the SLIC at consistently low ice shear temperatures, as shown in FIG. 5.

FIGS. 7 and 8 show that the crocking cloth abradant caused greater damage to the SLIC, relative to the medium-coarse abradant, which led to a larger decrease in sliding angles. The crocking cloth imparted a blunt force on the coating, which wiped and absorbed the silicone lubricant from the coating surface. Conversely, the medium-coarse abradant, which mimicked sand paper type abrasion, did not severely affect the sliding angles of the coating. Also note that the impact of supercooled drops (at approximately 25 m/s) on the coating did not affect the surface morphology and eventually the ice shear temperatures of the coating. In addition, the SLICs showed good adhesion to the metallic fan blades since they survived the acceleration forces that were being subjected to by the high rotational speeds during the ice shear test. Moreover, this was demonstrated without the need for using an adhesion primer. This acceleration was calculated to be 2,704 m/s² or approximately 276 g. Each ice shear test took approximately 1 hour to complete and therefore, it could be stated that the coatings survived these accelerations for 6 hours without delamination from the blades, nor did it affect the ice shear temperature.

In terms of achieving low ice adhesion and replenishing, the SLIC with 20% silicone oil infusion was effective. However, infusion of lubricants at high levels may cause the surface of the coating to be flooded with silicone oil. At some point, the coating can become visually oily and a portion of the coating can be removed by touching or wiping the surface. This may be desirable for enhanced icephobicity, although the presence of a large amount of lubricant can entrap foreign particles, such as dust particles. Such particles can be undesirable since they may alter the surface roughness and chemical composition of the coating. At 20% oil infusion, the coating exhibited some of these observations to some degree. However, such observations were not made for the SLIC with 10% oil infusion. In an example, an appropriate amount of oil infusion can be between about 10% and about 20%. In another example, an appropriate amount of oil infusion can be between about 10% and about 15%.

It is recognized that if the lubricant becomes completely depleted after an extended period of time, additional lubricants can be re-infused into the silicone elastomer.

### Additional Testing for Durability

Additional testing was performed on the SLICs to evaluate durability. Such durability tests included substrate durability tests and blade durability tests. The compositions shown in Table 1 were used for the SLICs at 5%, 10% and 20% oil infusion.

Additional testing included three types of substrate durability tests: tape-peel, taber linear abrasion, and thermal cycling. Substrate durability tests were performed on flat aluminum substrates. Three types of blade icing durability tests were performed by coating test blades with the compositions of the three SLICs and subjecting the blades to the following three durability tests, followed by an ice shear performance test: blade spinning to check for coating stability, sponged-back abrasion test, and thermal cycling. For the blade icing durability tests, the ice adhesion/ice shear performance test (described above in regard to FIG. 2) was conducted after the blades were subjected to each of the blade icing durability tests. Such additional testing established that the SLICs were able to withstand light abrasion and regain ice shear performance even after experiencing some damage.

### Results of Substrate Durability Tests

Tape-peel tests were performed according to ASTM standard D3359-09 with wet immersion to measure coating-substrate adherence. The SLICs at 5%, 10% and 20% oil-infusion showed 0% coating removed before and after peel for first and second tests. These results confirmed a strong coating to substrate adhesion.

Linear abrasion results for the coated substrates revealed that 2, 10 and 45 abrasion cycles were required to pin a droplet on the SLICs at 5%, 10% and 20% oil, respectively. However, it was observed that the SLICs contained a self-replenishing feature whereby the oil would migrate to the damaged coating area over time (13 days), thereby decreasing the sliding angle of the coating to its initial value prior to linear abrasion.

Low humidity thermal cycling was performed by subjecting the SLICs to 30 cycles of temperature fluctuations. The SLICs withstood thermal cycling and no structural damage to the coatings was observed. Slide-off angles of the SLICs were lower after thermal cycling, indicating that the thermal cycling promoted the migration of oil to the surface. Contact angles of the SLICs were generally unchanged. For contact and slide-off angles, six measurements were taken over two samples of each of the SLICs (at 5%, 10% and 20%) and the measurements were averaged.

Results of Blade Icing Durability Tests

Spinning durability was evaluated on the blades. Blades with the SLICs applied to the surface were spun for six hours at 1500 rpm at room temperature to evaluate stability of coating under centrifugal and aerodynamic shearing. The ice shear test described above (the results shown in FIGS. 5 and 6) was performed after to determine ice release performance (measured in terms of ice shear temperature).

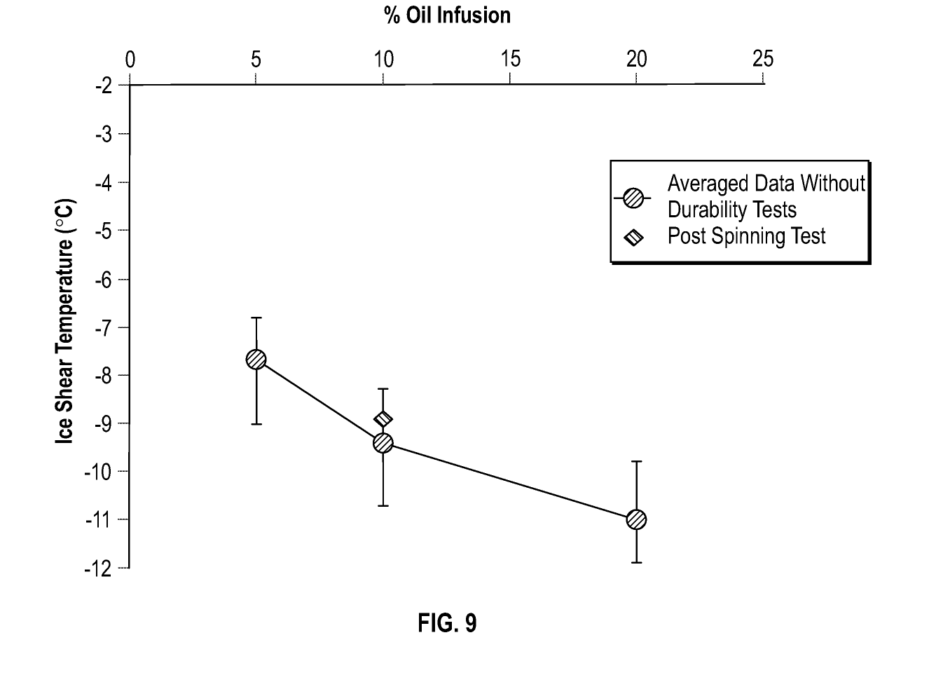

FIG. 9 illustrates the performance of the blades in terms of ice shear temperatures following the spinning durability test, as compared to the averaged ice shear temperatures for the SLICs without the durability test. Dust accumulation on a surface of the coatings was observed after the durability test. However, as shown in FIG. 9, no degradation of ice shear performance, which would have resulted from the durability test, was observed.

Blades with the SLICs applied to the surface were abraded by hand with Scotchbrite™ pads until an approximate loss of sliding angle was observed. Two abrasion tests were performed. Heating was performed after the second abrasion test. The ice shear test described above was performed after to determine ice release performance.

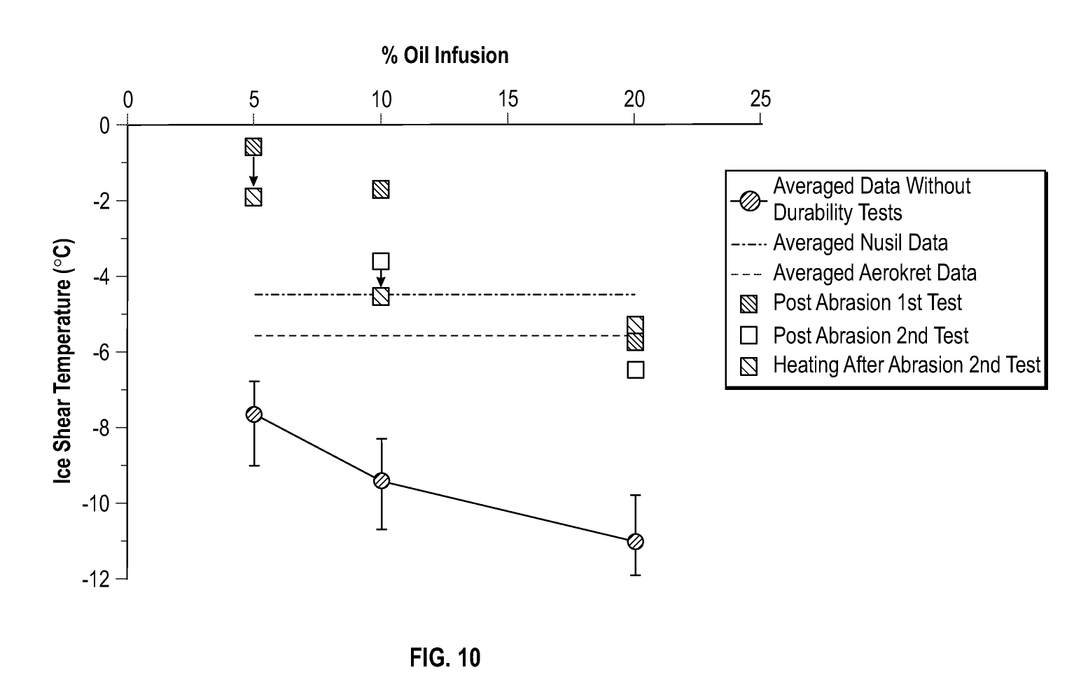

FIG. 10 shows the ice shear temperatures following the 1^{st} and 2^{nd} abrasion tests and following heating after the 2^{nd} abrasion test, as compared to the average ice shear temperatures for the SLICs without the durability tests. The averaged ice shear temperatures for Nusil and Aerokret are represented by dotted lines.

The results in FIG. 10 demonstrate that the post abrasion tests caused a significant degradation in ice adhesion performance, as indicated by the significant increase in ice shear temperature. However, the performance had some recovery over time (due to oil migration) and an external heat treatment. Note that the SLICs at oil-infusion levels of 10% and 20% had comparable performance to Nusil and Aerokret, respectively; however, the Nusil and Aerokret values represent performance of the Nusil and Aerokret coatings not subject to abrasion testing. Thus the ice shear performance of the SLICs is still believed to be superior to the Nusil and Aerokret coatings.

Thermal cycling was performed on blades with the SLICs applied to the surface. Such thermal cycling was performed by placing the blades in an incubator and subjecting the blades to 30 cycles with temperature cycling between 60 degrees Celsius and −10 degrees Celsius. The blades were tested twice within three days of post thermal cycling. The ice shear test described above was performed after to determine ice release performance.

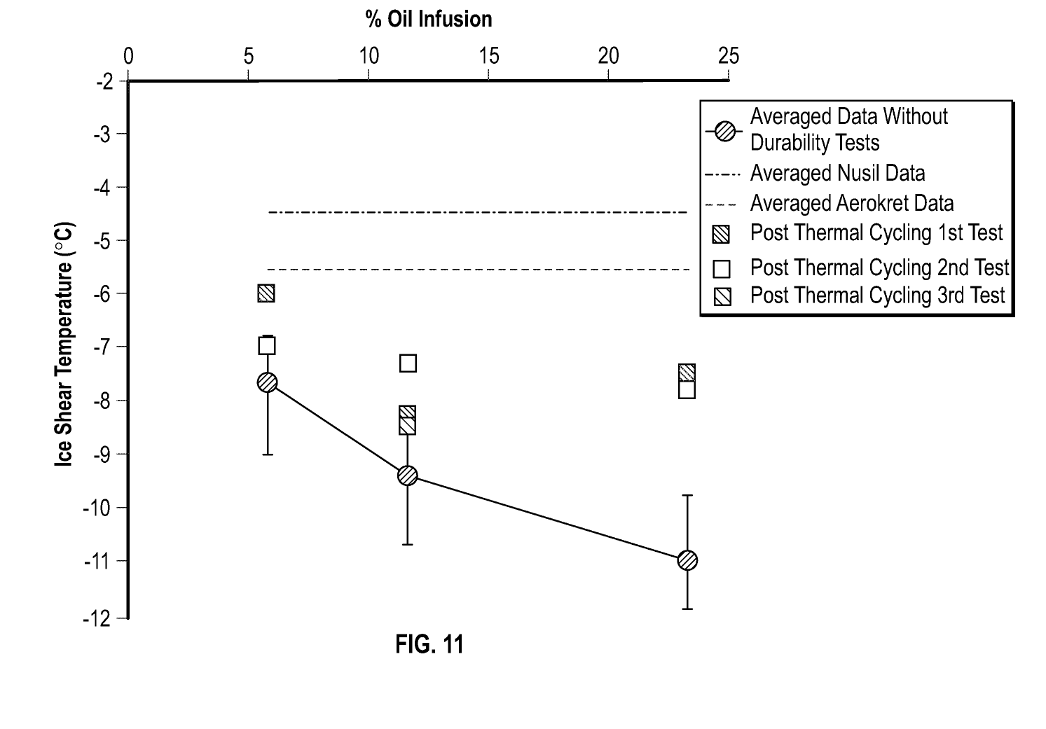

FIG. 11 shows the ice shear temperatures post thermal cycling tests, as compared to the average ice shear temperatures for the SLICs without thermal cycling tests. The averaged ice shear temperatures for Nusil and Aerokret (without thermal cycling) are represented by dotted lines.

The results in FIG. 11 demonstrate a slight degradation in ice removal, as compared to the averaged data for the SLICs not subject to thermal cycling. However, the ice shear temperatures of the SLICs at each of the oil-infusion levels performed better than the Nusil and Aerokret coatings not subject to thermal cycling.

### Evaluation of Optimal Amount of Xylene in Formulation

The tests on the SLICs described above were performed for SLICs having compositions with a 1:1 ratio of xylene to silicone elastomer. Additional testing demonstrated the impact that such ratio had on durability and ice adhesion.

Such additional testing including SLICs having a composition with a 0.5:1 ratio of xylene to silicone elastomer and comparing such SLICs to the above described SLICs having a 1:1 ratio of xylene to silicone elastomer (see Table 1). The SLICs at the 0.5:1 ratio were sprayed onto the surface, whereas the SLICs at the 1:1 ratio were drop-casted on to the surface. The weight percent of each of the three SLIC compositions at the 0.5:1 ratio of xylene to silicone elastomer is shown below in Table 3.

TABLE 3
Composition of SLICs at 0.5:1 ratio of Xylene to Silprocoat

| | Silprocoat wt % | Baysilone wt % | Xylene wt % |
|---|---|---|---|
| SLIC 5% | 64.4 | 3.4 | 32.2 |
| SLIC 10% | 62.0 | 7.0 | 31.0 |
| SLIC 20% | 57.1 | 14.3 | 28.6 |

FIG. 12 shows the ice shear temperatures of an SLIC at 10% oil and 0.5:1 ratio for multiple spray tests, as compared to the SLICs at the 1:1 ratio. Three ice shear tests were performed on the SLIC at 10% oil and 0.5:1 ratio. (The three tests are labeled as Silprocoat Spray Test 1, 2, and 3.)

As shown in FIG. 12, after the first test, the ice shear temperature was about −7 degrees Celsius, which is not markedly different from the ice shear temperature for the SLIC at 5% oil and 1:1 ratio. Similar results were observed after the second test. However, after the third test (which was measured t weeks later), the ice shear temperature of the SLIC at 10% oil and 0.5:1 ratio was markedly higher (approximately −4.5 degrees Celsius). However, even at this degraded state, the performance of the SLIC at 10% oil and 0.5:1 ratio was comparable to the Nusil performance.

The results in FIG. 12 demonstrate that although a 0.5:1 ratio is a viable option for the formulations to create the SLICs, the 1:1 ratio appears to provide superior performance in terms of ice adhesion.

### Coating Heating for Ice Protection (CHIP)

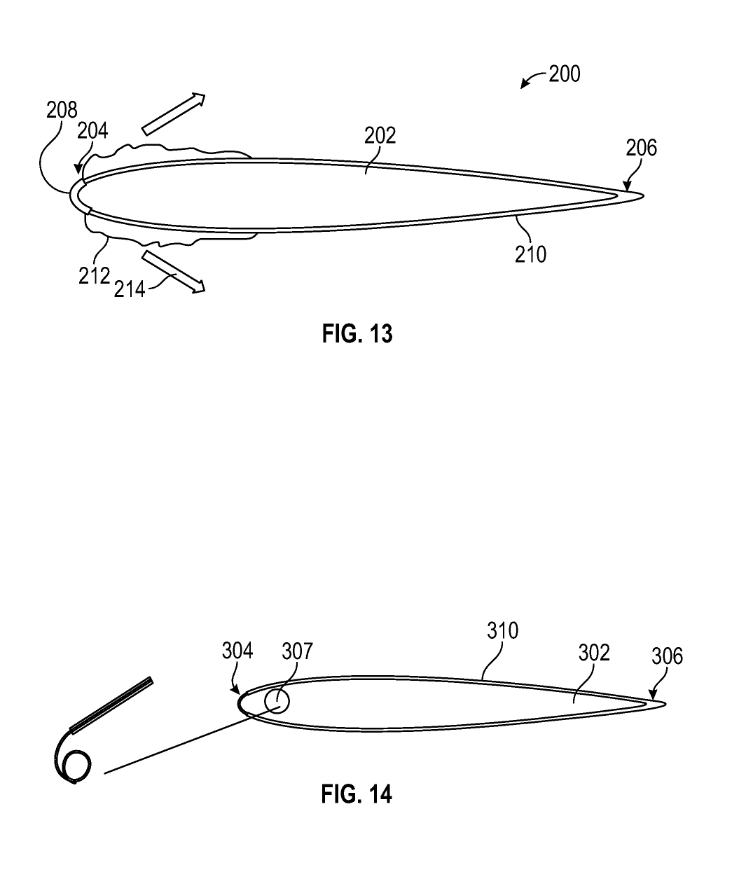

FIG. 13 is a schematic of an example system 200 that integrates the SLICs described herein with localized heating. The system 200 can be referred to as a Coating Heating for Ice Protection (CHIP) or CHIP system. FIG. 13 shows the CHIP system 200 installed on an airfoil 202 having a leading edge 204 and a trailing edge 206. The system 200 can be configured for use during operation of the aircraft for which the airfoil 202 is a part. The CHIP system 200 can include a heat element or heat source 208, installed on or around the leading edge 204, as well as a SLIC 210 applied to a remaining portion of the surface of the airfoil 202. In an example, the heating source 208 can include, but is not limited to, a resistive heating element.

In an example, the heat source 208 can be a metal foil that can wrap around the leading edge 204 of the airfoil 202. The metal foil can be flexible and electrically conductive. An example metal foil is a graphite foil, such as that sold by Kelly Aerospace. The inclusion of the metal foil 208 (or other heat source) on the leading edge 204 can result in little to no ice accretion on the surface of the leading edge 204, when the metal foil 208 is electrically heated. The metal foil 208 can be turned on and off depending on conditions. Moreover, the heating from the foil 208 can assist in creating a crack in ice 212 that may form near the leading edge 204, which can result in removal of the runback ice 212 through aerodynamic forces, as represented by arrows 214.

Given its low ice adhesion and durability, as detailed above, the SLIC 210 can effectively work in tandem with the heat source 208 by promoting low adhesion of the ice 212 that does form on the surface.

In the example of FIG. 13, essentially all of the surface of the airfoil 202 is coated with the SLIC 210, with the exception of the area having the heat source 208. The SLIC 210 can be applied generally uniformly, for example between about 100 and 200 μm, to the surface of the airfoil 202 or the SLIC 210 can be applied more heavily or more lightly in some areas of the surface, relative to other areas. In another example, even excluding the surface having the heat source 208, the SLIC 210 may not be applied to all exposed surfaces of the airfoil 202.

The airfoil 202 of FIG. 13 is an example of an aircraft component suitable for use with the CHIP system 200. It is recognized that the CHIP system 200 can be used for additional parts or components of an aircraft or other aeronautical machines. The CHIP system 200 can be well suited to for parts or components that traditionally have a coated applied thereto for ice conditions or a heating element attached thereto for heating during ice conditions. Such additional parts can include, for example, guide vanes.

FIG. 14 is a schematic of another example CHIP system 300 for use with an air foil 302 having a leading edge 304 and a trailing edge 306. Instead of a metal foil wrapped around the leading edge 304, the system 300 provides a heating element 307 that can be installed inside the airfoil 302 in proximity to the leading edge 304. The heating element 307 can be used in tandem with an SLIC coating 310 applied to some or all of the surfaces of the airfoil 302 surrounding the leading edge 304. In an example, the heating element 307 can be a tubular heater, such as a tubular heater sold by Omega Engineering.

As it is shown in FIG. 14, the coating 310 is not applied around the leading edge 304. However, it is recognized that the coating 310 may cover more of the coating edge 304 than what is shown in FIG. 14. Moreover, it is recognized that the composition may expand after the coating 310 is applied to the surface, such that the coating also covers the leading edge 304.

For simplicity, FIG. 14 excludes ice formed on the coating 310; however, it is recognized that the ice formation and break up can be the same as described above in reference to FIG. 13. The heating element 307, when in operation, can heat the surface of the leading edge 304 (and the immediately surrounding area), such that ice formation can be minimized or if ice is formed, a crack can be created to facilitate ice removal from the surface. For example, resistive heating can be used.

FIGS. 13 and 14 provide two examples of localized heating for use with the SLIC. It is recognized that other types of heating elements suitable for use on or inside the airfoil (or other aeronautical part or component) can be used in addition to or as an alternative to the examples described herein.

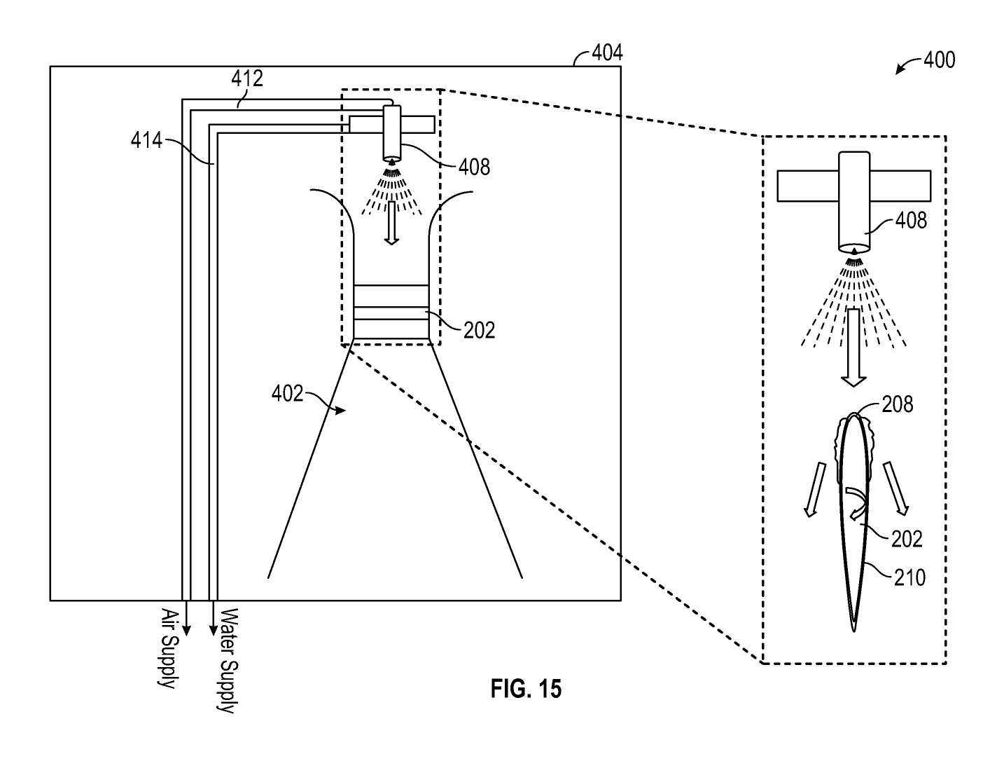

FIG. 15 is a schematic of an example testing system 400 configured for testing the CHIP system 200. It is recognized that the system 400 can also be suitable for testing the CHIP system 300 or similar CHIP systems with alternative heating components.

The testing system 400 can include a vertical wind tunnel 402 created inside a freezing chamber 404. A nozzle 408 can be similar to the nozzle 108 described above and shown in FIG. 2. As also described in reference to the system 100 of FIG. 2, the testing system 400 can include an air supply 412 and a water supply 414. The system 400 can be configured to receive and secure the air foil 202 at a predetermined distance away from the airfoil 202 such that water droplets from the nozzle 408 can contact the leading edge 204 of the airfoil 202 while the freezing chamber 404 is at cold temperatures and the airfoil 202 is exposed to low wind speeds within the wind tunnel 402. In an example, the vertical wind tunnel 402 can be a commercial wind tunnel, for example a Flotek 250 Research Grade Tunnel from GDJ Inc. or a Pitsco Air Tech Tunnel.

The testing system 400 can be operated for a selected period of time and then the airfoil 402 can be tested, using some or all of the tests described herein, to determine the ice adhesion effectiveness of the CHIP system 200.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

### VARIOUS NOTES & EXAMPLES

The present application provides for the following exemplary embodiments or examples, the numbering of which is not to be construed as designating levels of importance:

Example 1 provides an aircraft anti-icing system comprising an oil-infused silicone elastomer composition for use as an ice-phobic coating. The composition can comprise a silicone elastomer ranging between about 43 and about 65 weight percent of the composition, a silicone oil ranging between about 2.5 and about 14.5 weight percent of the composition, and xylene ranging between about 28 and about 50 weight percent of the composition. The silicone oil is infused into the silicone elastomer and the composition is configured to be coated onto an aircraft component.

Example 2 provides the system of Example 1 optionally configured such that the silicone elastomer ranges between about 43 and about 50 weight percent of the composition, the silicone oil ranges between about 2.5 and about 14.0 weight percent of the composition, and the xylene ranges between about 43 and about 50 weight percent of the composition.

Example 3 provides the system of Example 1 optionally configured such that the silicone elastomer ranges between about 44 and about 47.5 weight percent of the composition, the silicone oil ranges between about 5 and about 11.5 weight percent of the composition, and the xylene ranges between about 44 and about 47.5 weight percent of the composition.

Example 4 provides the system of any one of Examples 1-3 optionally configured such that the weight percent of the silicone elastomer in the composition is about equal to the weight percent of the xylene in the composition.

Example 5 provides the system of any one of Examples 1-4 optionally configured such that the composition is moisture-cured.

Example 6 provides the system of any one of Examples 1-5 optionally configured such that the composition has a water contact angle of about 105 when measured through the sessile drop method.

Example 7 provides the system of any one of Examples 1-6 optionally configured such that the composition has a slide off angle less than 20.

Example 8 provides the system of Example 7 optionally configured such that the slide-off angle is between about 7 and about 18.

Example 9 provides the system of any one of Examples 1-8 optionally configured such that the silicone elastomer comprises suspended nanoparticles.

Example 10 provides the system of any one of Examples 1-9 optionally configured such that the silicone elastomer comprises quartz nanocrystals.

Example 11 provides the system of any one of Examples 1-10 optionally further comprising a heating component for placement on a leading edge of the aircraft component or inside the aircraft component in proximity to a leading edge. The oil-infused silicone elastomer composition is applied as a coating on a surface of the aircraft component surrounding the leading edge. The heating component is used in combination with the oil-infused silicone elastomer composition to minimize ice adhesion on the surface of the aircraft component.

Example 12 provides the system of Example 11 wherein the heating component includes at least one of a tubular heater and an electrically conductive foil.

Example 13 provides an oil-infused silicone elastomer composition for use as an ice-phobic coating. The composition can comprise a silicone elastomer comprising amorphous silicon dioxide and crystalline silicon dioxide, a silicone oil ranging between about 5 and 20 weight percent relative to a weight percent of the silicone elastomer, and a solvent. The silicone oil is infused into the silicone elastomer and the composition is configured to be coated onto an aircraft component to form an ice-phobic coating.

Example 14 provides the composition of Example 13 optionally configured such that the solvent is xylene.

Example 15 provides the composition of either of Example 13 or 14 optionally configured such that a weight percent of the solvent in the composition is about equal to a weight percent of the silicone elastomer in the composition.

Example 16 provides the composition of Example 15 optionally configured such that the weight percent of the silicone elastomer in the composition ranges between about 43 and about 50, the weight percent of the silicone oil in the composition ranges between about 2.5 and about 14.0, and the weight percent of the solvent in the composition ranges between about 43 and about 50.

Example 17 provides the composition of either of Example 13 or 14 optionally configured such that the weight percent of the silicone elastomer in the composition ranges between about 43 and about 65, the weight percent of the silicone oil in the composition ranges between about 2.5 and about 14.5, and the weight percent of the solvent in the composition ranges between about 28 and about 50.

Example 18 provides the composition of any of Examples 13-17 optionally configured such that the crystalline silicon dioxide in the silicone elastomer is in the form of quartz nanocrystals.

Example 19 provides the composition of Example 18 optionally configured such that a weight percent of the quartz nanocrystals in the silicone elastomer is greater than a weight percent of the amorphous silicon dioxide in the silicone elastomer.

Example 20 provides a method of making an oil-infused elastomer composition for use as an ice-phobic coating. The method can comprise mixing a silicone elastomer with xylene to form an intermediate composition. A weight percent of the silicone elastomer in the intermediate composition is approximately equal to a weight percent of the xylene in the intermediate composition. The method can further comprise adding a silicone oil to the intermediate composition to form an oil-infused elastomer composition. A weight percent of the silicone oil in the oil-infused elastomer composition ranges between about 5 and about 20 weight percent relative to the weight percent of the silicone elastomer in the oil-infused elastomer composition.

Example 21 provides the method of Example 20 optionally configured such that the weight percent of the silicone oil in the oil-infused elastomer composition ranges between about 10 and about 15 weight percent relative to the weight percent of the silicone elastomer in the oil-infused elastomer composition.

Example 22 provides the method of either of Example 20 or 21 optionally configured such that the silicone elastomer includes suspended nanoparticles.

Example 23 provides the method of Example 22 optionally configured such that the suspended nanoparticles are crystalline quartz.

Example 24 provides a method of forming an oil-infused elastomer coating on an aircraft component. The method can comprise making or providing a composition comprising xylene ranging between about 43 and about 50 weight percent of the composition, a silicone elastomer ranging between about 43 and about 50 weight percent of the composition, and a silicone oil ranging between about 2.5 and about 14 weight percent of the composition. The silicone oil is infused into the silicone elastomer. The method can further comprise applying the composition to a least a portion of the surface of the aircraft component and curing the composition at ambient conditions to form the oil-infused elastomer coating on the surface of the aircraft component.

Example 25 provides the method of Example 24 optionally configured such that applying the composition to at least a portion of the surface of the aircraft component includes at least one of drop casting, flow coating, spin coating, dip coating, and spraying.

Example 26 provides the method of Example 25 optionally configured such that spraying the composition is performed using an airless spray gun or a high volume low pressure (HVLP) spray gun.

Example 27 provides the method of any of Examples 24-26 optionally configured such that applying the composition to at least a portion of the surface of the aircraft component includes applying two or more layers of the composition onto the aircraft component, and wherein curing the composition is performed after applying each layer.

Example 28 provides the method of either of Example 24 or 25 optionally configured such that the composition comprises xylene ranging between about 44 and about 47.5 weight percent of the composition, silicone elastomer ranging between about 44 and about 47.5 weight percent of the composition, and silicone oil ranging between about 5 and about 11.5 weight percent of the composition.

Example 29 provides a method of protecting one or more components of an aircraft from ice formation during operation of the aircraft. The method can comprise installing a heating element inside or on an aircraft component, proximate to a leading edge of the aircraft component. The method can further comprise making or providing a composition comprising a silicone elastomer infused with silicone oil and applying the composition on a surface of the aircraft component surrounding the leading edge to create a self-lubricating ice-phobic coating. The heating element and the coating can work in combination to protect the aircraft component from ice formation.

Example 30 provides the method of Example 29 optionally configured such that installing a heating element includes installing a tube heater inside the airfoil.

Example 31 provides the method of Example 29 optionally configured such that installing a heating element includes attaching an electrically conductive foil to an exterior surface at and around the leading edge of the aircraft component.

Example 32 provides the method of any one of Examples 29-31 optionally configured such that applying the composition on the surface of the aircraft component includes at least one of drop casting, flow coating, spin coating, dip coating, and spraying.

Example 33 provides the method of any one of Examples 29-32 optionally configured such that applying the composition on the surface of the aircraft component includes applying two layers of the composition on the surface.

Example 34 provides the method of Example 33 optionally further comprising curing the composition after each layer is applied on the surface.

Example 35 provides the method of Example 34 optionally configured such that curing the composition includes moisture curing at ambient conditions for less than 8 hours.

Example 36 provides the method of any of Examples 29-35 optionally configured such that the composition comprises xylene ranging between about 43 and about 50 weight percent of the composition, the silicone elastomer ranging between about 43 and about 50 weight percent of the composition, and the silicone oil ranging between about 2.5 and about 14 weight percent of the composition.

Example 37 provides a testing system for evaluating ice adhesion and can comprise an icing chamber configured to cool the air in the icing chamber to at or below −20 degrees Celsius and a motor-driven propeller configured to receive a plurality of fan blades and rotate the plurality of fan blades. A portion of the plurality of fan blades can have a surface coating for evaluation. The system can further comprise a spray nozzle connected to a water supply and an air supply, the spray nozzle configured to spray water droplets onto tips of each fan blade during rotation of the fan blades by the propeller.

Example 38 provides the system of Example 37 optionally configured such that the propeller is configured to receive four fan blades.

Example 39 provides the system of either of Example 37 or 38 optionally configured such that the propeller is contained with a protective enclosure.

Example 40 provides the system of Example 39 optionally configured such that the protective enclosure includes a removable cover having a spray aperture for delivery of the water droplets to the rotating fan blades.

Example 41 provides the system of any of Examples 37-40 optionally configured such that the propeller rotates the fan blades at about 1000 rpm.

Example 42 provides a method of evaluating ice adhesion on fan blades coated with a hydrophobic or icephobic coating. The method can comprise mounting two or more fan blades on a motor-driven propeller configured to rotate the fan blades at speeds up to about 1000 rpm, the propeller housed within a chamber, and cooling the chamber to a temperature at or below 0 degrees Celsius. The method can further comprise spraying droplets through an atomizing nozzle connected to an air supply and a water supply, and directing the droplets onto the rotating fan blades to accrete ice on the blades. The method can further comprise turning off cooling to the chamber, turning off the atomizing nozzle, and determining the temperature in the chamber at which ice on the rotating blades sheared from the rotating blades

Example 43 provides the method of Example 42 optionally configured such that cooling the chamber includes cooling the chamber to 20 degrees below Celsius.

Example 44 provides the method of either of Example 42 or 43 optionally configured such that directing the droplets onto the rotating fan blades includes impacting the blades with supercooled drops at about 25 m/s.

Example 45 provides the method of any of Examples 42-44 optionally configured such that directing the droplets onto the rotating fan blades comprises installing a protective cover over the propeller, the protective cover having an aperture, and aligning the nozzle with the aperture of the protective cover such that the droplets are directed through the aperture and onto tips of the blades as the blades are rotating.

Example 46 provides the method of any of Examples 42-45 optionally configured such that conducting a pre-test spray after cooling the chamber and prior to directing the droplets onto the rotating fan blades.

Example 47 provides the method of Example 46 optionally configured such that conducting a pre-test spray includes deflecting the spray from the atomizing nozzle away from the fan blades.

Example 48 provides a system or method of any one or any combination of Examples 1-47, which can be optionally configured such that all steps or elements recited are available to use or select from.

Various aspects of the disclosure have been described. These and other aspects are within the scope of the following claims.

1: An aircraft anti-icing system comprising:
an oil-infused silicone elastomer solution for use as an ice-phobic coating, the oil-infused silicone elastomer solution comprising:
a silicone elastomer ranging between about 43 and about 65 weight percent of the oil-infused silicone elastomer solution;
a silicone oil ranging between about 2.5 and about 14.5 weight percent of the oil-infused silicone elastomer solution; and
xylene ranging between about 28 and about 50 weight percent of the oil-infused silicone elastomer solution,
wherein the silicone oil is infused into the silicone elastomer and the oil-infused silicone elastomer solution is configured to be coated onto an aircraft component.

2. (canceled)

3: The system of claim 1, wherein the silicone elastomer ranges between about 44 and about 47.5 weight percent of the oil-infused silicone elastomer solution, the silicone oil ranges between about 5 and about 11.5 weight percent of the oil-infused silicone elastomer solution, and the xylene ranges between about 44 and about 47.5 weight percent of the oil-infused silicone elastomer solution.

4: The system of claim 1, wherein the weight percent of the silicone elastomer in the oil-infused silicone elastomer solution is about equal to the weight percent of the xylene in the oil-infused silicone elastomer solution.

5: The system of claim 1, wherein the oil-infused silicone elastomer solution is moisture-cured.

6: The system of claim 1, wherein the oil-infused silicone elastomer solution has a water contact angle of about 105 when measured through the sessile drop method and a slide off angle less than 20.

7-8. (canceled)

9: The system of claim 1, wherein the silicone elastomer comprises suspended nanoparticles.

10: The system of claim 1, wherein the silicone elastomer comprises quartz nanocrystals.

11: The system of claim 1, wherein the system further comprises:
a heating component for placement on a leading edge of the aircraft component or inside the aircraft component in proximity to a leading edge,
wherein the oil-infused silicone elastomer solution is applied as a coating on a surface of the aircraft component surrounding the leading edge, and
wherein the heating component is used in combination with the oil-infused silicone elastomer solution to minimize ice adhesion on the surface of the aircraft component.

12. (canceled)

13: An oil-infused silicone elastomer composition for use as an ice-phobic coating, the composition comprising:
a silicone elastomer comprising amorphous silicon dioxide and crystalline silicon dioxide;
a silicone oil ranging between about 5 and 20 weight percent relative to a weight percent of the silicone elastomer; and
a solvent,
wherein the silicone oil is infused into the silicone elastomer and the composition is configured to be coated onto an aircraft component to form an ice-phobic coating.

14: The oil-infused silicon elastomer composition of claim 13, wherein the solvent comprises xylene.

15: The composition of claim 13, wherein a weight percent of the solvent in the oil-infused silicon elastomer composition is about equal to a weight percent of the silicone elastomer in the oil-infused silicon elastomer composition.

16: The composition of claim 15, wherein the weight percent of the silicone elastomer in the oil-infused silicon elastomer composition ranges between about 43 and about 50, the weight percent of the silicone oil in the oil-infused silicon elastomer composition ranges between about 2.5 and about 14.0, and the weight percent of the solvent in the oil-infused silicon elastomer composition ranges between about 43 and about 50.

17. (canceled)

18: The composition of claim 13, wherein the crystalline silicon dioxide in the silicone elastomer is in the form of quartz nanocrystals.

19: The composition of claim 18 wherein a weight percent of the quartz nanocrystals in the silicone elastomer is greater than a weight percent of the amorphous silicone dioxide in the silicone elastomer.

20-23. (canceled)

24: A method comprising:
applying a solution to a least a portion of the surface of an aircraft component, wherein the solution comprises:
xylene ranging between about 43 and about 50 weight percent of the solution;
a silicone elastomer ranging between about 43 and about 50 weight percent of the solution; and
a silicone oil ranging between about 2.5 and about 14 weight percent of the solution, the silicone oil infused into the silicone elastomer; and
curing the composition at ambient conditions to form the oil-infused elastomer coating on a surface of an aircraft component.

25: The method of claim 24, wherein applying the solution to at least a portion of the surface of the aircraft component includes at least one of drop casting, flow coating, spin coating, dip coating, and spraying.

26: The method of claim 25 wherein spraying the solution is performed using an airless spray gun or a high volume low pressure (HVLP) spray gun.

27: The method of claim 24 wherein applying the solution to at least a portion of the surface of the aircraft component includes applying two or more layers of the solution onto the aircraft component, and wherein curing the solution is performed after applying each layer.

28: The method of claim 24, wherein the solution comprises xylene ranging between about 44 and about 47.5 weight percent of the solution, silicone elastomer ranging between about 44 and about 47.5 weight percent of the solution, and silicone oil ranging between about 5 and about 11.5 weight percent of the solution.

29: The method of claim 24, further comprising:
installing a heating element inside or on an aircraft component, proximate to a leading edge of the aircraft component.

30-47. (canceled)
